(19) United States
(12) Patent Application Publication
(10) Pub. No.: US 2003/0065838 A1
(43) Pub. Date: Apr. 3, 2003

(54) Method and system for attaching multiple clock sources to an SDRAM memory array

(76) Inventor: Mark E. Eidson, Tempe, AZ (US)

Correspondence Address: KENYON & KENYON, 1500 K STREET, N.W., SUITE 700, WASHINGTON, DC, 20005, US

(21) Appl. No.: 09/964,736

(22) Filed: Sep. 28, 2001

(51) Int. Cl. G06F 13/00; G06F 1/12

(52) U.S. Cl. 710/100; 713/400

(57) ABSTRACT

According to embodiments of the invention, multiple memory bus masters of a computer board are connected via transmission lines to a common node. The common node is further connected to a memory array. Each memory bus master can drive clock signals to the memory array. An isolation circuit is placed between the transmission lines and the common node. The isolation circuit is controllable to select one of the memory bus masters to drive clock signals to the memory array, while isolating the transmission lines of the other bus masters from the common node to reduce clock signal corruption.

### TECHNICAL FIELD

The present invention relates to computer board layout, and more particularly to a method and system for improving clock signal integrity in a board layout wherein there are multiple clock sources for a memory array.

### BACKGROUND OF THE INVENTION

In many typical computer board (also, “motherboard”) layouts, there is only one memory bus master, the processor. However, designs have advanced such that computer boards can include multiple possible memory bus masters. For example, board layouts such as those incorporating Intel® Xscale™ or Intel® StrongArm™ processors support a memory bus mastering scheme which allows for multiple bus masters. The multiple bus masters could comprise, for example, the processor, a “companion” chip of the processor, and a FPGA (Field Programmable Gate Array).

Clock topologies for memory arrays in computer board designs with only one memory bus master are typically configured to minimize or eliminate clock skew and jitter where possible. One aspect of minimizing skew and jitter involves using a single, centralized clock source for the memory. A further aspect of minimizing skew and jitter involves configuring the board layout to make trace lengths from the centralized clock source to individual memory modules substantially equal, so that clock signal propagation times to each module are substantially the same. Further, regulating feedback signals are provided to the clock source.

Accordingly, in order to conform to typical clock topologies, a clock topology for a system with multiple memory bus masters could appear as shown in FIG. 1. That is, a centralized clock source 100 could have inputs CLKIN0, CLKIN1 and CLKIN2 connected to clock signals CLKOUT_BM0, CLKOUT_BM1 and CLKOUT_BM2, respectively. Signals CLKOUT_BM0, CLKOUT_BM1 and CLKOUT_BM2 represent independent clock signals from each of a plurality of possible memory bus masters, each of which could read from or write to the system memory. In FIG. 1, a memory array is represented by SDRAM (synchronous dynamic random access memory) modules 101. Each of the possible bus masters could supply an independent clock driving signal to the array via CLKIN0, CLKIN1 or CLKIN2.

Signals MBGNT_BM0, MBGNT_BM1 and MBGNT_BM2, representing control signals from a memory bus arbiter, could further be input to the clock source 100 at inputs INSEL0, INSEL1 and INSEL2, respectively, to select which of the possible bus masters was to be given access to the memory array and drive clock signals to the array. Signals OUTPUT4, OUTPUT5 and OUTPUT6 of the clock source 100 could be connected to inputs CLKIN_BM0, CLKIN_BM1 and CLKIN_BM2, respectively, of each bus master, to provide a regulating feedback signal to each bus master.

The clock source 100 has multiple clock outputs, OUTPUT0-OUTPUT3, each of which drives the same clock signal (either CLKIN0, CLKIN1 or CLKIN2) via a point-to-point connection to a clock input (CLK) of each SDRAM module 101. Trace lengths from the clock source 100 to each SDRAM module 101 may be substantially equal so that signal propagation times to each SDRAM module are substantially the same. Further, the clock source 100 has an output signal, OUTPUT7, which is fed back as a regulating reference signal, REFIN.

Notwithstanding the advantages that could be realized by a layout as illustrated in FIG. 1 for a board with multiple memory bus masters, there are practical concerns which render such an implementation infeasible in many cases. For example, the need to provide a feedback input from the centralized clock source, as described above, for each bus master, would increase the complexity and cost of whatever logic was acting as the bus master.

Thus, instead of using a centralized clock source 100 with multiple clock outputs as shown in FIG. 1, a system with multiple memory bus masters might instead connect a clock driving signal from each bus master to a common node connected to the clock inputs of the memory array. Such an implementation would avoid the increased cost and complexity of an implementation which used a centralized clock source.

However, such an arrangement would also have attendant signal corruption problems. The clock signals of the individual memory bus masters would need to be connected by transmission lines from different points on the board layout (i.e., from wherever a particular bus master happened to be located) to the common node. Thus, the transmission lines could be comparatively long and of unequal lengths. As the clocks signals propagated across the transmission lines, undesirable phenomena such as reflection, ringing, and increased clock skew and jitter could be introduced in the clock signals. These undesirable phenomena would be exacerbated by the high frequencies which are typical of current processors.

Approaches to handling such problems could include, for example, placing load matching impedances at the outputs of the bus masters, to alleviate the effects of reflection. However, this would also increase the cost and complexity of the board circuitry.

Accordingly, an approach to connecting multiple memory bus masters to a memory array is needed that addresses the concerns noted in the foregoing.

### BRIEF DESCRIPTION OF THE DRAWINGS

FIG. 1 shows a clock topology for a memory array in a computer board layout wherein there is a centralized clock source and multiple memory bus masters; and

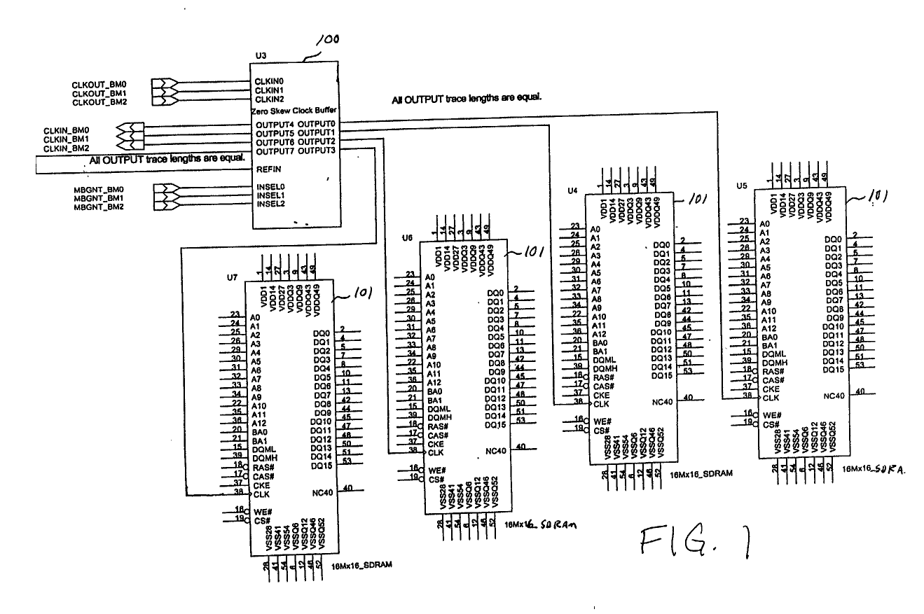

FIG. 2 shows a memory array driven by multiple memory bus masters with an isolating circuit according to an embodiment of the invention.

### DETAILED DESCRIPTION

In embodiments of the invention, clock signals driven by multiple memory bus masters may be connected by transmission lines to a common node which is in turn connected to clock inputs of a memory array. An isolating circuit may be placed in the transmission line between each memory bus master and the common node. The isolating circuit may be controlled by memory bus arbitration signals to select one bus master to drive clock signals to the memory array, while selecting the transmission lines of the other bus masters for isolation from the common node, by introducing a high impedance between the transmission lines and the common node to eliminate signal corruption effects.

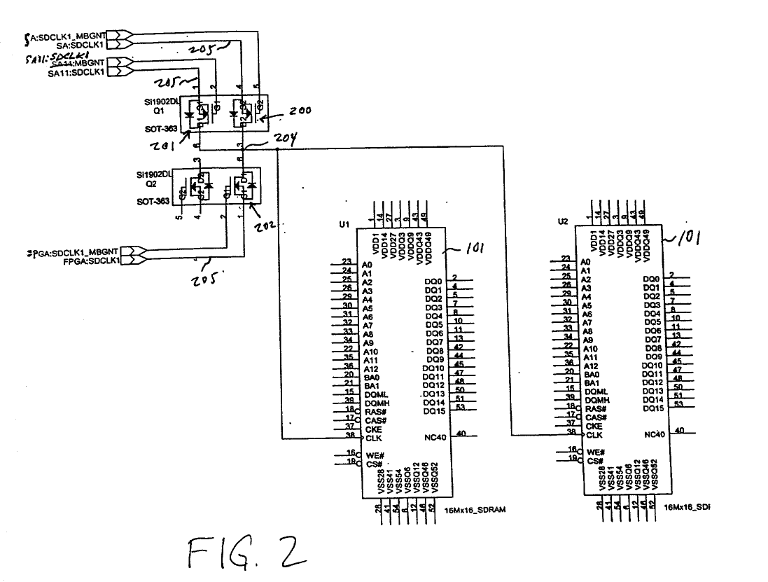

FIG. 2 shows one such possible embodiment. In FIG. 2, clock signals generated by three possible memory bus masters are shown: SA:SDCLK1, SA11:SDCLK1 and FPGA:SDCLK1. (It should be understood that these signal names, and signal names identified hereinafter, are arbitrary and given by way of example only to illustrate of the principles of the invention.) The memory bus masters corresponding to signals SA:SDCLK1, SA11:SDCLK1 and FPGA:SDCLK1 could be any kind of logic configured to drive signals to a memory bus, and having an independent clock source. For example, according to an embodiment of the invention, signals SA:SDCLK1, SA11:SDCLK1 and FPGA:SDCLK1 could correspond, respectively, to a processor, a “companion” chip of the processor, and a field programmable gate array (FPGA). However, there could be more than three possible bus masters, and the bus masters could be logic chips of different types from the examples given.

FETs (field effect transistors) 200, 201 and 202 and associated connections constitute one possible embodiment of an isolation circuit as described above. Each of the memory bus master clock signals is connected via a transmission line 205 to the source electrode of one of FETs 200, 201 and 202. More particularly, SA:SDCLK1 is connected to the source electrode of FET 200, SA11:SDCLK1 is connected to the source electrode of FET 201, and FPGA:SDCLK1 is connected to the source electrode of FET 202. The drain electrodes of each of FETs 200, 201 and 202 are connected to a common node 204. The common node 204, in turn, is connected to the clock inputs of each of the SDRAM modules 101. (It should be understood that, for convenience, FIG. 2 shows transmission lines 205 in a schematic representation. In actuality, the transmission lines 205 could be of significantly different lengths and approach the common node 204 from different directions, depending upon where the bus master generating the clock source was located in the board layout.)

Each of the memory bus master clock signals may be associated with a control signal from a memory bus arbiter. For example, SA:SDCLK1 may associated with control signal SA:SDCLK1_MBGNT, SA11:SDCLK1 may be associated with control signal SA11:SDCLK1_MBGNT, and FPGA.SDCLK1 may be associated with control signal FPGA:SDCLK1_MBGNT. Control signals SA:SDCLK1_MBGNT, SA11:SDCLK_MBGNT and FPGA:SDCLK1_MBGNT may be connected, respectively, to the gate electrodes of FETs 200, 201 and 202.

A memory bus arbiter (not shown) may drive signals SA:SDCLK1_MBGNT, SA11:SDCLK1_MBGNT and FPGA:SDCLK1_MBGNT, and thus may determine which of the possible bus masters will drive clock signals to the memory array represented by the SDRAM modules 101. The SA:SDCLK1_MBGNT, SA11:SDCLK1_MBGNT and FPGA:SDCLK1_MBGNT signals apply biasing voltages to the gate electrodes of the respective FETs they are connected to, to turn the FETs on and off as needed to select one bus master to drive clock signals to the array, while selecting the transmission lines of the other bus masters for isolation from the common node to preserve clock signal integrity.

For example, the memory bus arbiter could determine that the bus master corresponding to the clock signal SA:SDCLK1 was to be given access to the memory bus. In such a case, the memory bus arbiter could output a high value for control signal SA:SDCLK1_MBGNT, and low values for each of control signals SA11:SDCLK1_MBGNT and FPGA:SDCLK1_MBGNT. The high value for control signal SA:SDCLK1_MBGNT would cause FET 200 to conduct, allowing the bus master corresponding to clock signal SA:SDCLK1 to drive clock signals to the SDRAM modules 101. The low values for control signals SA11:SDCLK1_MBGNT and FPGA:SDCLK1_MBGNT, on the other hand, would cause FETs 201 and 202 to be non-conducting, thereby introducing a high impedance at these points and isolating the transmission lines from the respective bus masters to the memory array. Unwanted reflections, ringing, and other undesirable signal corrupting influences would thereby be eliminated.

Similarly, the memory bus arbiter could determine that the bus master corresponding to the clock signal SA11:SDCLK1 was to be given access to the memory bus. In such a case, the memory bus arbiter could output a high value for control signal SA11:SDCLK1_MBGNT, and low values for each of control signals SA:SDCLK1_MBGNT and FPGA:SDCLK1_MBGNT. The high value for control signal SA:SDCLK1_MBGNT would cause FET 201 to conduct, allowing the bus master corresponding to clock signal SA11:SDCLK1 to drive clock signals to the SDRAM modules 101. The low values for control signals SA:SDCLK1_MBGNT and FPGA:SDCLK1_MBGNT would cause FETs 200 and 202 to isolate the transmission lines from the other bus masters to the memory array.

In a like manner, to allow the bus master corresponding to clock signal FPGA.SDCLK1 to drive clock signals to the memory array while isolating the transmission lines of the other bus masters, the bus arbiter could output a high value for FPGA.SDCLK1_MBGNT1 and low values for SA:SDCLK1_MBGNT and SA11:SDCLK1_MBGNT.

It should be understood that the isolation circuit comprising FETs as in above-described embodiment is only one possible implementation; different transistor types could be used. Additionally, an isolation circuit could, for example, be implemented in a multiplexer with control inputs from a memory bus arbiter.

In view of the above, an efficient and low cost system and method for improving clock signal integrity in a computer board layout having multiple possible memory bus masters connected at a common node to a memory array has been disclosed.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A system comprising:
a plurality of memory bus masters, each to generate an independent clock signal on respective outputs, each of said outputs connected by a transmission line to a common node, said common node additionally connected to a plurality of clock inputs of a memory array; and
an isolation circuit coupled between each of said transmission lines and said common node.

2. The system of claim 1, further comprising control inputs connected to said isolation circuit, to select one of said plurality of memory bus masters to drive a corresponding clock signal to said memory array while isolating the transmission lines of the other bus masters from said common node.

3. The system of claim 2, wherein said control inputs are supplied by a memory bus arbiter.

4. The system of claim 1, wherein said isolation circuit places a high impedance between said common node and said transmission lines.

5. The system of claim 1, wherein said isolation circuit comprises a plurality of FETs.

6. The system of claim 1, wherein said isolation circuit is a multiplexer.

7. In a computer board layout including a memory array and plurality of memory bus masters, a method comprising:
connecting each of said bus masters to a common node via a transmission line;
connecting said memory array to said common node; and
placing an isolation circuit between each of said transmission lines and said common node.

8. The method of claim 8, further comprising:
providing control inputs to said isolation circuit to select one of said bus masters to drive a clock inputs to said memory array while isolating the transmission lines of the other bus masters from said common node.

9. A circuit comprising:
a plurality of transmission lines coupled between respective bus master clock outputs and a common node;
a plurality of memory modules coupled to said common node; and
an isolation circuit coupled between said plurality of transmission lines and said common node.

10. The circuit of claim 9, further comprising:
control means connected to said isolation circuit, said control means being configured to select one of said bus master clock outputs to drive to said memory modules, while selecting the transmission lines associated with the other bus master clock signals for isolation from said common node.

11. The circuit of claim 9, wherein a clock input of each of said memory modules is connected to said common node.

12. The circuit of claim 9, where said memory modules are SDRAM modules.

13. A method comprising:
connecting transmission lines from a plurality of memory bus masters to a common node;
connecting a memory array to said common node;
selecting one of said memory bus masters to drive clock outputs to said memory array; and
introducing a high impedance between the transmission lines of the other memory bus masters and said common node.

14. The method of claim 13, wherein said selected bus master is selected by control inputs from a memory bus arbiter.

15. The method of claim 13, wherein said high impedance comprises FETs.
